(19) United States
(12) Patent Application Publication
(10) Pub. No.: US 2007/0152080 A1
(43) Pub. Date: Jul. 5, 2007

(54) Fuel injector with directly triggered injection valve member

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/586,053

(22) PCT Filed: Nov. 16, 2004
(86) PCT No.: PCT/EP04/52980

§ 371 Date: Jul. 14, 2006

(30) Foreign Application Priority Data
Jan. 16, 2004 (DE) 10 2004 002 299.

(51) Int. Cl. B05B 1/08

(52) U.S. Cl. 239/102.2; 239/533.3

(57) ABSTRACT

A fuel injector having a piezoelectric actuator directly actuating an injection valve member, which piezoelectric actuator acts on a booster piston, and a face end of the booster piston acts on a hydraulic coupling chamber for actuating the injection valve member, and the piezoelectric actuator is received in a hollow chamber in the injector housing, which hollow chamber is filled with a fuel volume that is under high pressure. The diameter of a sealing edge in the actuator base region corresponds to the diameter of the booster piston.

### FIELD OF THE INVENTION

In self-igniting internal combustion engines, at present besides other injection systems, the reservoir or “common rail” injection system is also employed. The essential characteristic of the common rail system is that the injection pressure can be generated independently of the engine rpm and of the injection quantity. Decoupling the pressure generation and the injection is done with the aid of a reservoir volume. This volume that is definitive for the function is composed of components in the common rail, in the high-pressure lines, and in the injector itself.

### PRIOR ART

Fuel injectors by way of which fuel is injected into the combustion chamber of an internal combustion engine can be actuated via fast-switching magnet valves or via piezoelectric actuators. In previously known embodiments, a piezoelectric actuator or magnet valve acts on a closing element, which closes or opens a relief conduit of a control chamber. As a function of the closing or opening of the closing member, which can be embodied spherically or conically, an actuation of an injection valve member, such as a nozzle needle, takes place. The control chamber in the injector body is continuously acted upon by high pressure via an inlet throttle. As soon as the valve closing member is actuated by the piezoelectric actuator or by the fast-switching magnet valve, a control volume flows out of the control chamber via a line that contains an outlet throttle, and the control chamber is thus pressure-relieved. It is attained by this means that the face end of the injection valve member enters into the control chamber and uncovers its seat toward the combustion chamber, so that by way of the injection openings embodied there in a nozzle body, fuel is injected into the combustion chamber of the self-igniting internal combustion engine.

In the embodiments known from the prior art, the actuation of the injection valve member is done indirectly via a pressure relief of the control chamber, which effects the opening and closing of the injection valve member, which latter can be embodied in the form of a needle.

The trend in development is now in the direction of direct triggering of an injection valve member. If for that purpose piezoelectric actuators are used instead of fast-switching magnet valves, then for reasons of installation space the piezoelectric actuator is embedded in a fuel volume that is at high pressure. As a rule, the fuel volume is at system pressure, or in other words the pressure level that prevails in the high-pressure reservoir (common rail) of the fuel injection system. As a rule, piezoelectric actuators are embodied as layered piezoelectric crystal stacks, which change their length when current is supplied to the piezoelectric actuator. If piezoelectric actuators are located inside a fuel volume, then because of the design of the piezoelectric actuators, upon subjection to a fuel volume, unwanted forces on the piezoelectric actuator result. In direct triggering of the injection valve member, these resultant forces affect its stroke length within the injector body, especially at high rpm, so that the instants of injection, or the fuel quantities injected into the combustion chamber, drift or in other words can be reproduced only very inaccurately.

### SUMMARY OF THE INVENTION

According to the invention, a solution to this problem is proposed in which a direct triggering of the injection valve member by a piezoelectric actuator is possible. The embodiment proposed according to the invention is distinguished in that the piezoelectric actuator, which is surrounded by fuel, is designed such that the base region of the piezoelectric actuator, located in the fuel volume, and a booster piston actuated directly by the head region of the piezoelectric actuator, which booster piston is part of the injection valve member, have the same diameters. The result is identical hydraulically operative faces at which, when pressure is exerted on the hollow chamber inside the injector body in which the piezoelectric actuator is received, no resultant hydraulic forces which impair the useful stroke of the injection valve member, guided movably in the injector body, occur.

The piezoelectric actuator surrounded inside the injector body by fuel at high pressure has a sealing edge in its head region, and the sealing edge diameter is preferably identical to the diameter of the booster piston that directly communicates with the piezoelectric actuator head region. As a result of this embodiment, it can be attained on the one hand that the booster piston, which acts upon a hydraulic coupling chamber, transmits the length of the piezoelectric crystal stack exactly when current is supplied to the piezoelectric actuator; on the other, because of the embodiment proposed according to the invention, outflow conduits, outflow throttles, valve closing elements, and guides for the valve closing elements, all previously required, can be dispensed with. This has a favorable effect on the structural height of an injection valve member directly triggered by way of a piezoelectric actuator embodied according to the invention, since the aforementioned transmission elements can be dispensed with.

### DRAWING

The invention is described in further detail below in conjunction with the drawing.

Shown are:

FIG. 1, a longitudinal section through a fuel injector, proposed according to the invention, with a piezoelectric actuator integrated with the high-pressure inlet; and

FIG. 2, an enlarged view of a sealing edge of the hollow chamber shown in FIG. 1.

### VARIANT EMBODIMENTS

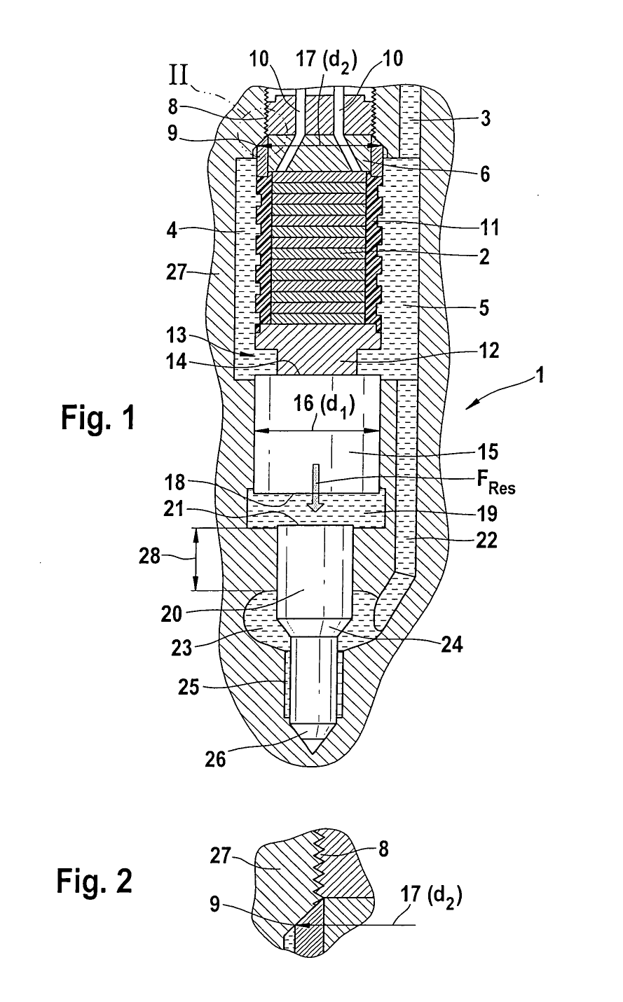

In FIG. 1, a fuel injector 1 is shown, which is actuated by means of a piezoelectric actuator 2. The piezoelectric actuator 2 is received within a fuel volume 5. The fuel volume 5 is located inside a hollow chamber 4, embodied in the injector body 27 of the fuel injector 1. The hollow chamber 4 is subjected to the fuel volume 5 via a high-pressure inlet 3. The high-pressure inlet 3 in turn communicates fluidically with a reservoir volume (common rail) not shown in FIG. 1. In the common rail, a system pressure level of approximately 1300 bar or more, maintained by a high-pressure fuel pump, prevails.

The piezoelectric actuator 2 received inside the hollow chamber 4 in FIG. 1 includes both an actuator base 6 and an actuator head 12.

The piezoelectric actuator 2 includes a number of piezoelectric crystals, layered one above the other and oriented in stack form, which when current is supplied to the piezoelectric actuator 2 via electrical terminals 10 change their length, so that the piezoelectric actuator 2 causes a reciprocating motion of a booster piston 5 directly connected to it.

In the upper region of the piezoelectric actuator 2, the piezoelectric actuator 2 is sealed off at the actuator base 6 by a metal threaded part 8. Located below the metal threaded part 8 is a sealing edge 9, which is embodied with the sealing edge diameter 17 (d₂). The sealing edge 9 embodied on the piezoelectric actuator 2 rests on a suitably beveled conical face of the housing 27 of the fuel injector 1. The piezoelectric crystal stack, not shown in FIG. 1, may optionally be surrounded by a potting material 11, in order to improve the resistance of the piezoelectric actuator 2 to fuel.

At the actuator head 12 of the piezoelectric actuator 2, this piezoelectric actuator is solidly joined to a booster piston 15, which is embodied with a diameter 16 (d₁). The sealing edge diameter 17 (d₂) and the booster piston diameter 16 (d₁) are identical. The booster piston 15 is guided movably in the injector housing 27 of the fuel injector 1. Above a connecting face 14, the piezoelectric actuator has a constriction 13 in the actuator head region 12.

The lower face end 18, pointing toward a hydraulic coupling chamber 19, of the booster piston 15 acts upon a fuel volume contained in the hydraulic coupling chamber 19. The hydraulic coupling chamber 19 is defined on the other end by an end face 21 of an injection valve member 20 embodied in the form of a needle. The diameter of the face end 18 is equivalent to the diameter of the booster piston 16 and is greater than the diameter of the face end 21 of the needle-like injection valve member 20 that is received movably in the vertical direction in the injector body 27. The injection valve member 20 is received in a guide length 28 in the injector body 27.

From the hollow chamber 4, into which the fuel volume 5 flows via the high-pressure inlet 3, a nozzle chamber inlet 22 branches off. Via the nozzle chamber inlet 22, fuel at system pressure flows to a nozzle chamber 23 embodied in the injector body 27. On the injection valve member 20, a pressure step 24 is embodied, which is engaged by the fuel flowing into the nozzle chamber 23 at system pressure, and at the pressure step 24, the injection valve member 20 generates a force that actuates the injection valve member 20 in the opening direction. From the nozzle chamber 23, an annular gap 25 also extends, by way of which fuel flows in the direction of a tip 26 of the injection valve member 20, which can be embodied as a nozzle needle.

The injection openings, by way of which fuel flows into a combustion chamber of a self-igniting internal combustion engine, are not shown in detail in FIG. 1.

FIG. 2 shows the sealing edge, embodied in the actuator base region 6 and cooperating with the injector housing, in an enlarged view.

A threaded portion 8 is located in the upper region of the piezoelectric actuator 2 that is let into the hollow chamber 4. Since the sealing of the hollow chamber 4, acted upon by fuel 5 at high pressure, that can be established via a thread 8 is not adequate, a sealing edge 9 is provided in the actuator base region 6 of the piezoelectric actuator 2. The sealing edge 9 cooperates with a frustoconical sealing seat on the injector housing 27. The sealing edge diameter 17 (d₂) designates the point at which the sealing edge 9 touches the frustoconical sealing face of the injector housing 27 and assures sealing off of the hollow chamber 4, which is filled with a fuel volume 5 that is at high pressure.

For the embodiment shown in FIGS. 1 and 2 of the piezoelectric actuator 2, received in a hollow chamber 4 that is acted upon by fuel 5 at high pressure, the identity of the sealing edge diameter 17 and the booster piston diameter 16 is characteristic. If these diameters 16 (d₁) and 17 (d₂) are identical, then no resultant force (Fᵣₑₛ=0) on the piezoelectric actuator 2 in the useful stroke direction is exerted by the fuel volume 5, at high pressure, that is received in the hollow chamber 4 of the injector housing 27.

If the piezoelectric crystal stack contained in the piezoelectric actuator 2 is supplied with current, then because of the change in length of the piezoelectric actuator 2, the booster piston 15 solidly joined to it moves with its face end 18 into the hydraulic coupling chamber 19, so that the needle-like injection valve member 20 is pressed into its seat against the combustion chamber, so that the injection openings into the combustion chamber of a self-igniting internal combustion engine remain closed. If the current supply to the actuator 2 contained in a piezoelectric crystal arrangement is stopped, then because of the absence of lengthening of the piezoelectric crystal stack contained in the piezoelectric actuator 2, the booster piston 15 moves out of the hydraulic coupling chamber 19, so that the face end 21 of the needle-like injection valve member 20 moves in the opening direction, and fuel flows out of the nozzle chamber 23 via the annular gap 25 to the tip 26 of the needle-like injection valve member 20 and can be injected, via the injection openings, not shown in FIG. 1, into the combustion chamber of the self-igniting internal combustion engine.

The pressure equilibrium of the piezoelectric actuator 2, which is received inside the hollow chamber 4 that is filled with the fuel volume 5 at high pressure, assures the maximum utilization of the useful stroke of the piezoelectric actuator 2, since no force hindering the expansion of the piezoelectric crystals, which are received in a stacked arrangement, is counteracted, and hence the maximum stroke range of the piezoelectric actuator when current is supplied to it and when the current is stopped, that is, the restoration of the original shape of the piezoelectric crystals, is enabled. In piezoelectric actuators 2, this is of great significance from the standpoint that the change in length of a piezoelectric crystal stack amounts to only a few micrometers, and the resultant forces that affect this change in length can impair the maximum useful stroke of the piezoelectric actuator 2 considerably.

### LIST OF REFERENCE NUMERALS

1 Fuel injector
2 Piezoelectric actuator
3 High-pressure inlet
4 Hollow chamber
5 Fuel volume (system pressure)
6 Actuator base region
7 Actuator base diameter
8 Threaded portion
9 Sealing edge
10 Electrical terminals
11 Potting material
12 Actuator head region
13 Constriction
14 Connecting face
15 Booster piston
16 Diameter of booster piston (d₁)
17 Sealing edge diameter (d₂)
18 Face end of booster piston
19 Hydraulic coupling chamber
20 Needle-like injection valve member
21 Face end of injection valve member
22 Nozzle chamber inlet
23 Nozzle chamber
24 Pressure step
25 Annular gap
26 Tip of injection valve member
27 Injector body
28 Guide length of injection valve member

1-8. (canceled)

9. In a fuel injector having a piezoelectric actuator directly actuating an injection valve member, which piezoelectric actuator acts on a booster piston, and a face end of the booster piston acts on a hydraulic coupling chamber for actuating the injection valve member, and the piezoelectric actuator is received in a hollow chamber in the injector housing, which hollow chamber is filled with a fuel volume that is under high pressure, the improvement wherein the diameter (d2) of a sealing edge in the actuator base region corresponds to the diameter (d₁) of the booster piston.

10. The fuel injector in accordance with claim 9, wherein the piezoelectric actuator, on its head region, is solidly joined to the booster piston.

11. The fuel injector in accordance with claim 9, wherein the face end of the booster piston, acting on a hydraulic coupling chamber, forms a larger hydraulically operative face than a face end of the injection valve member defining the hydraulic coupling chamber.

12. The fuel injector in accordance with claim 10, wherein the face end of the booster piston, acting on a hydraulic coupling chamber, forms a larger hydraulically operative face than a face end of the injection valve member defining the hydraulic coupling chamber.

13. The fuel injector in accordance with claim 9, wherein the piezoelectric actuator is surrounded by a potting material.

14. The fuel injector in accordance with claim 9, wherein the hollow chamber in the injector housing surrounding the piezoelectric actuator acts on a nozzle chamber inlet extending to a nozzle chamber.

15. The fuel injector in accordance with claim 10, wherein the hollow chamber in the injector housing surrounding the piezoelectric actuator acts on a nozzle chamber inlet extending to a nozzle chamber.

16. The fuel injector in accordance with claim 11, wherein the hollow chamber in the injector housing surrounding the piezoelectric actuator acts on a nozzle chamber inlet extending to a nozzle chamber.

17. The fuel injector in accordance with claim 9, wherein electrical terminals for supplying current to the piezoelectric actuator are guided by a threaded portion located above the actuator base region.

18. The fuel injector in accordance with claim 10, wherein electrical terminals for supplying current to the piezoelectric actuator are guided by a threaded portion located above the actuator base region.

19. The fuel injector in accordance with claim 11, wherein electrical terminals for supplying current to the piezoelectric actuator are guided by a threaded portion located above the actuator base region.

20. The fuel injector in accordance with claim 13, wherein electrical terminals for supplying current to the piezoelectric actuator are guided by a threaded portion located above the actuator base region.

21. The fuel injector in accordance with claim 14, wherein electrical terminals for supplying current to the piezoelectric actuator are guided by a threaded portion located above the actuator base region.

22. The fuel injector in accordance with claim 9, wherein the a sealing edge, cooperating with a beveled portion of the injector housing and embodied in the base region of the piezoelectric actuator seals off the hollow chamber, which is filled with a fuel volume at high pressure, from the threaded portion.

23. The fuel injector in accordance with claim 10, wherein the a sealing edge, cooperating with a beveled portion of the injector housing and embodied in the base region of the piezoelectric actuator seals off the hollow chamber, which is filled with a fuel volume at high pressure, from the threaded portion.

24. The fuel injector in accordance with claim 11, wherein the a sealing edge, cooperating with a beveled portion of the injector housing and embodied in the base region of the piezoelectric actuator seals off the hollow chamber, which is filled with a fuel volume at high pressure, from the threaded portion.

25. The fuel injector in accordance with claim 13, wherein the a sealing edge, cooperating with a beveled portion of the injector housing and embodied in the base region of the piezoelectric actuator seals off the hollow chamber, which is filled with a fuel volume at high pressure, from the threaded portion.

26. The fuel injector in accordance with claim 9, wherein the piezoelectric actuator, above a connecting face with the booster piston, has a constricted portion.

27. The fuel injector in accordance with claim 10, wherein the piezoelectric actuator, above a connecting face with the booster piston, has a constricted portion.

28. The fuel injector in accordance with claim 11, wherein the piezoelectric actuator, above a connecting face with the booster piston, has a constricted portion.
